(19) United States
(12) Patent Application Publication
(10) Pub. No.: US 2024/0295245 A1
(43) Pub. Date: Sep. 5, 2024

(54) HYDRAULICALLY BRAKEABLE ELECTRICAL MACHINE

(71) Applicant: VOLVO TRUCK CORPORATION, Göteborg (SE)

(72) Inventors: Rasmus ANDERSSON, Hisings Backa (SE); John Lord, Olofstorp (SE)

(73) Assignee: VOLVO TRUCK CORPORATION, Göteborg (SE)

(21) Appl. No.: 18/582,761

(22) Filed: Feb. 21, 2024

(30) Foreign Application Priority Data
Mar. 2, 2023 (EP) 23159547.1

(51) Int. Cl. F16D 57/04; B60T 10/02; F16D 125/02; H02K 7/10

(52) U.S. Cl. CPC F16D 57/04; B60T 10/02; H02K 7/10; F16D 2125/023

(57) ABSTRACT

An electrical machine is presented. The electrical machine comprises a rotor, a stator, a housing and a first and a second fluid chamber in fluid communication via at least one fluid passage of the rotor. The rotor upon rotation is adapted to provide a difference in pressure between the first fluid chamber and the second fluid chamber by transfer of fluid there between, whereby a braking torque is exerted on the rotor.

### TECHNICAL FIELD

The disclosure relates generally to electrical machines. In particular aspects, the disclosure relates to hydraulically breakable electrical machines. The disclosure can be applied to general electrical machines and in particular to electrical propulsion machines for heavy-duty vehicles, such as trucks, buses, and construction equipment, among other vehicle types. Although the disclosure may be described with respect to a particular vehicle, the disclosure is not restricted to any particular vehicle.

### BACKGROUND

Modern vehicles may be provided with electrical machines. One particular use of electric machines in vehicles is for traction purpose, i.e. the electrical machines are arranged as part of the drive train to perform the desired propulsion of the vehicle. These electrical machines are connected to one or more battery arrangements which provide the electrical machines with the required electrical power.

Electrical machines can also be used to provide retardation of the vehicle, changing the operational mode of the electrical machine from propulsion mode to regeneration mode. In such case the regeneration of electrical power will cause a retarding effect on the vehicle.

However, braking of the electric vehicle using the electrical machine can only be performed as long as the associated battery arrangement is capable of receiving the regenerated electrical power. If the battery arrangement is fully (or close to fully) charged, braking can no longer be achieved by means of the electrical machine.

Some vehicles utilize a brake resistor to dissipate excess power from regenerative braking also when the battery arrangement is fully charged. This option is comparably expensive.

Based on this, there is a need for improved solutions enabling the electrical machine of a vehicle to brake the vehicle even if the associated battery arrangement is not capable of receiving the generated electrical power.

### SUMMARY

In a first aspect, an electrical machine is presented. The electrical machine comprises a rotor, a stator, a housing and a first and a second fluid chamber in fluid communication via at least one fluid passage of the rotor. The rotor, upon rotation, is adapted to provide a difference in pressure between the first fluid chamber and the second fluid chamber by transfer of fluid there between, whereby a braking torque is exerted on the rotor. The first and second fluid chambers are provided at, along a rotational axis of the electrical machine, respective opposite sides of the rotor. A technical benefit may comprise providing a braking effect internal to the electrical machine with very few design modifications to the electrical machine, and that a distance between the rotor and the stator may be reduced to reduce losses.

In some examples, including in at least one preferred example, optionally, the first and second fluid chambers are provided between an interior of the housing and the rotor. This is beneficial as it provides a clearly delimited and straight forward delimitation of the fluid chamber.

In some examples, including in at least one preferred example, optionally, the at least one fluid return passage is provided between the first fluid chamber and the second fluid chamber. This is beneficial as it allows the electrical machine to be self-resettable after a braking effect has been exerted.

In some examples, including in at least one preferred example, optionally, at least one internal fluid return passage is provided between the stator and the rotor. This is beneficial as such a fluid return passage may be provided with minimum redesign of the electrical machine.

In some examples, including in at least one preferred example, optionally, the first fluid chamber is provided with a first chamber fluid port for fluidly filling and/or draining the first fluid chamber and the second fluid chamber is provide with a second chamber fluid port for fluidly filling and/or draining the second fluid chamber. This is beneficial as the fluid ports enables further means of controlling a flow of fluid and to perform service and maintenance on the electrical machine.

In some examples, including in at least one preferred example, optionally, the first chamber fluid port is in fluid communication with the second chamber fluid port by a fluid port return passage. This is beneficial as it allows the electrical machine to be self-resettable after a braking effect has been exerted.

In some examples, including in at least one preferred example, optionally, the fluid port return passage between the first and second chamber fluid ports is provided with at least one controllable valve device configurable to control a flow of fluid in the fluid port return passage. This is beneficial as it allows the braking effect to be controlled by control of the controllable valve device.

In some examples, including in at least one preferred example, optionally, the first fluid chamber comprises a first chamber fluid inlet for receiving fluid and a first chamber fluid outlet for draining fluid, and the second fluid chamber comprises a second chamber fluid inlet for receiving fluid and a second chamber fluid outlet for draining fluid. This is beneficial as the fluid ports, outlets, inlets enables further means of controlling a flow of fluid and to perform service and maintenance on the electrical machine.

In some examples, including in at least one preferred example, optionally, the rotor is provided with at least one impeller arranged at the first or the second fluid chamber of the electrical machine. This is beneficial as it increases a flow of fluid through the fluid passages.

In a second aspect, a vehicle comprising the electrical machine according to the first aspect is presented.

In some examples, including in at least one preferred example, optionally, the electrical machine is a propulsion motor of the vehicle. This is beneficial as a fluid brake will be incorporated in the propulsion motor of the vehicle.

In some examples, including in at least one preferred example, optionally, the vehicle further comprises a fluid circuit connected between the first chamber fluid port and the second chamber fluid port. This is beneficial as the fluid circuit enables further means of controlling a flow of fluid and to perform service and maintenance on the electrical machine.

In some examples, including in at least one preferred example, optionally, the fluid circuit comprises at least one pump device configurable to pump fluid into a the first fluid chamber or the second fluid chamber and at least one drain valve device configurable to prevent fluid from draining from the other of the first fluid chamber or the second fluid chamber. This is beneficial as the fluid circuit enables further means of controlling a flow of fluid and to perform service and maintenance on the electrical machine.

In some examples, including in at least one preferred example, optionally, an inlet valve device is provided between the pump device and the fluid receiving one of the first chamber fluid port and the second chamber fluid port. This is beneficial as the fluid circuit enables further means of controlling a flow of fluid and to perform service and maintenance on the electrical machine.

In some examples, including in at least one preferred example, optionally, the fluid circuit further comprises a fluid reservoir. A technical benefit may include increased braking capacity, since the reservoir may hold a larger volume of oil. A further technical benefit may include increased, when applicable, cooling capacity, as heat can be dissipated more efficiently.

In some examples, including in at least one preferred example, optionally, the fluid circuit is operatively connected to a temperature system of the vehicle. This is beneficial as it allows heat from the fluid to be exchanged with other parts of the vehicle, decreasing a cooling time of the fluid.

In some examples, including in at least one preferred example, optionally, the vehicle is a heavy-duty vehicle, such as a truck, a bus, or a construction equipment.

In a third aspect, a method for braking an electrical machine of the first aspect is presented. The method comprises providing fluid to a fluid chamber at a first axial side of the electrical machine, pumping, responsive to rotation of a rotor of the electrical machine, the fluid from the fluid chamber at the first axial side of the electrical machine to a fluid chamber at a second opposite axial side of the electrical machine through at least one fluid passage extending along the rotor of the electrical machine, and controlling a reverse flow of fluid from the second axial side to the first axial side such that the flow through the at least one fluid passage exceeds the reverse flow, whereby a braking torque is exerted on the rotor by the fluid at the second axial side of the electrical machine.

In a fourth aspect, an electrical machine is presented. The electrical machine comprises a rotor, a stator, a housing and a first and a second fluid chamber in fluid communication via at least one fluid passage of the rotor. The rotor, upon rotation, is adapted to provide a difference in pressure between the first fluid chamber and the second fluid chamber by transfer of fluid there between, whereby a braking torque is exerted on the rotor. The first and second fluid chambers are provided at, along a rotational axis of the electrical machine, respective opposite sides of the rotor. The first and second fluid chambers are provided between an interior of the housing and the rotor. The electrical machine further comprises at least one fluid return passage provided between the first fluid chamber and the second fluid chamber. At least one internal fluid return passage is provided between the stator and the rotor. The first fluid chamber is provided with a first chamber fluid port for fluidly filling and/or draining the first fluid chamber and the second fluid chamber is provide with a second chamber fluid port for fluidly filling and/or draining the second fluid chamber. The first chamber fluid port is in fluid communication with the second chamber fluid port by a fluid port return passage. The fluid port return passage between the first and second chamber fluid ports is provided with at least one controllable valve device configurable to control a flow of fluid in the fluid port return passage. The first fluid chamber comprises a first chamber fluid inlet for receiving fluid and a first chamber fluid outlet for draining fluid. The second fluid chamber comprises a second chamber fluid inlet for receiving fluid and a second chamber fluid outlet for draining fluid. The at least one fluid passage of the rotor is provided by an impeller of the rotor. The electrical machine is a propulsion motor for a vehicle.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is an exemplary side view of a vehicle according to some examples.

FIG. 2A is an exemplary cross-sectional view of an electrical machine according to some examples.

FIG. 2B is an exemplary cross-sectional view of an electrical machine according to some examples.

FIG. 3 is an exemplary cross-sectional view of an electrical machine according to some examples.

FIG. 4 is an exemplary cross-sectional view of an electrical machine according to some examples.

FIG. 5A is an exemplary cross-sectional view of a rotor forming part of an electrical machine according to some examples.

FIG. 5B is an exemplary cross-sectional view of a rotor forming part of an electrical machine according to some examples.

FIG. 5C is an exemplary cross-sectional view of a rotor forming part of an electrical machine according to some examples.

FIG. 6A is an exemplary cross-sectional view of a rotor forming part of an electrical machine according to some examples.

FIG. 6B is an exemplary cross-sectional view of a rotor forming part of an electrical machine according to some examples.

FIG. 7 is an exemplary block diagram of an electrical machine forming part of a fluid circuit of a vehicle according to some examples.

FIG. 8 is an exemplary schematic view of a method of braking an electrical motor according to some examples.

### DETAILED DESCRIPTION

The detailed description set forth below provides information and examples of the disclosed technology with sufficient detail to enable those skilled in the art to practice the disclosure.

Details of an electrical machine will be described in the following. The electrical machine according to the present disclosure aims to add a braking functionality to the electrical machine by utilizing oil or any other suitable fluid. Such oil may be oil already provided to e.g., cool down the electrical machine during operation. By implementing the electrical machine in a vehicle, a braking force may be applied to the vehicle by means of the electrical machine even if regeneration of electrical power is not available due to e.g. the associated battery arrangement being fully, or almost fully, charged.

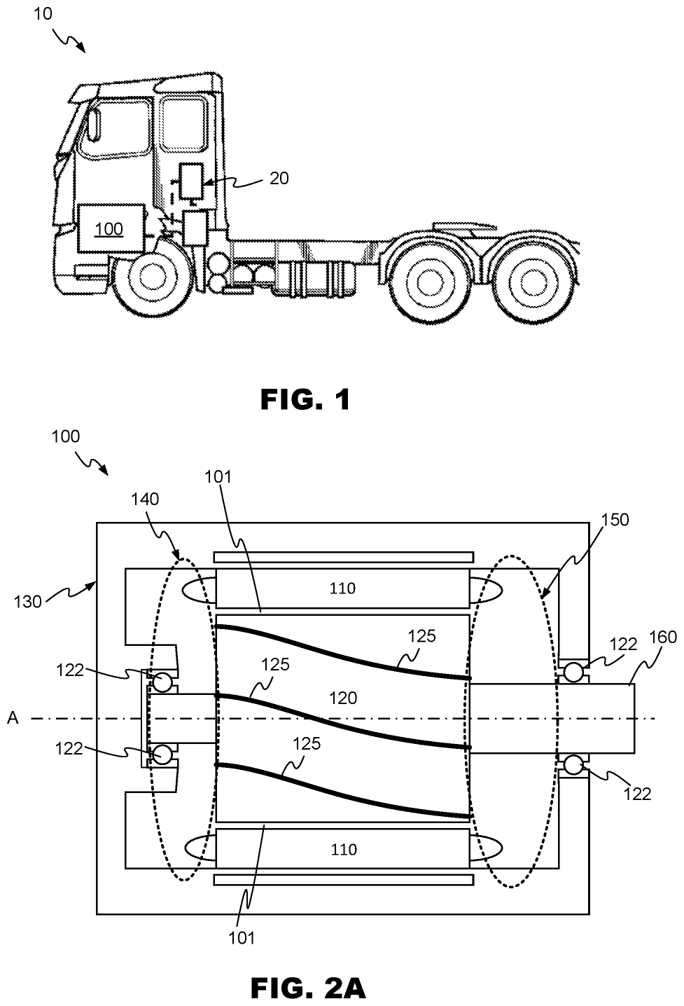

With reference to FIG. 1, a vehicle 10, here embodied as a heavy duty truck 10, is disclosed for which an electrical machine 100 and a method 200 (see FIG. 8) for braking an electrical machine 100 are advantageous. However, the electrical machine 100 and/or the method 200 may as well be implemented in other types of applications, in particular in other types of vehicles such as a busses, light-weight trucks, passenger cars, marine applications, etc.

The vehicle 10 is preferably an electric vehicle, such as a full electric vehicle or a hybrid vehicle, comprising at least one electrical machine 100 for propulsion. Typically the vehicle 10 also comprises an energy storage system 20 comprising energy storage or energy transformation devices, typically batteries or fuel cells. The energy storage system 20 is arranged and configured to power the electrical machine 100.

The vehicle 10 typically further comprises other parts of a powertrain such as a transmission, drive shafts, and wheels (not shown in details in FIG. 1).

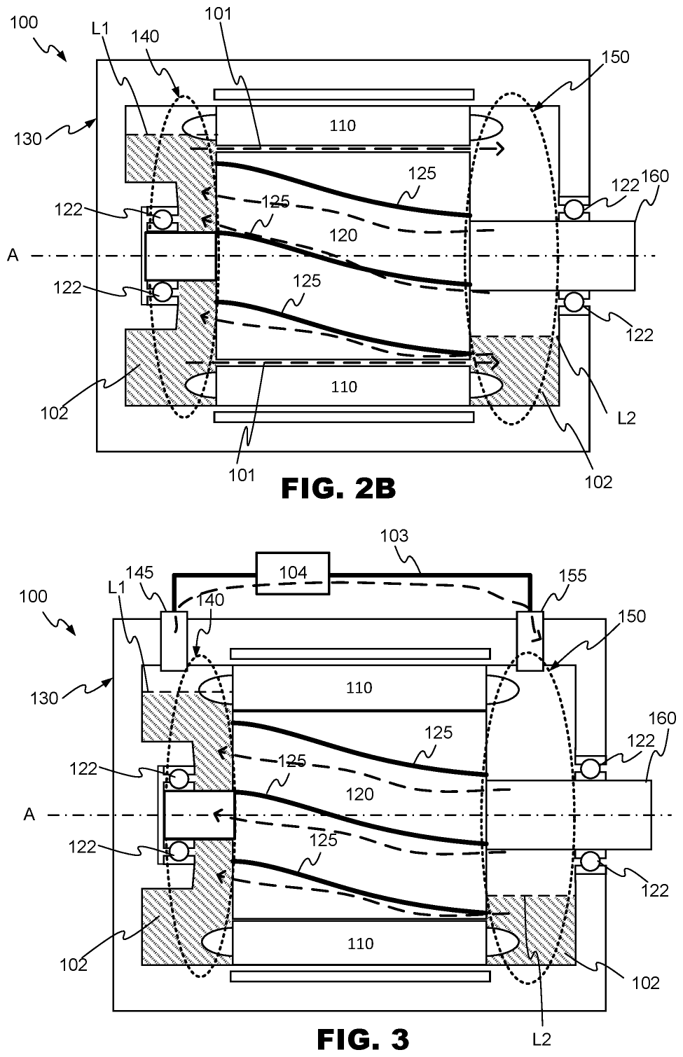

An example of an electrical machine 100 is shown in FIG. 2A. The electrical machine 100 has a rotor 120, a stator 110, and a housing 130. The rotor 120 is rotatably supported by the housing 130 e.g. by means of one or more bearings 122, allowing the rotor 120 to rotate around a rotational axis A. The stator 110 is also enclosed by the housing 130 and arranged radially to the rotational axis A outside of the rotor 110.

The electrical machine 100 is further provided with a first fluid chamber 140 and the second fluid chamber 150 between the rotor 120 and the housing 130. The fluid chambers 140, 150 are arranged along the rotational axis A, one at either side of the rotor 120. The fluid chambers 140, 150 are configured such that a braking torque is exerted on the rotor 120 responsive to a fluid pressure in the fluid chambers 140, 150. This braking torque will provide a braking effect on the rotor 120.

In order to provide for the desired braking effect, the rotor 120 comprises one or more fluid passages 125, sometimes referred to as channels 125. In the shown example, the rotor 120 is provided with a plurality of fluid passages 125 substantially evenly distributed around the rotor 120. The fluid passages 125 extend along the rotor 120 from a first axial side at the first fluid chamber 140 to an opposite second axial side at the second fluid chamber 150. Each fluid passage 125 is configured to guide fluid, advantageously oil, from the first fluid chamber 140 to the, along the second fluid chamber 150 along the rotational axis A. The fluid passages 125 and/or the axial side(s) of the rotor 120 and/or the fluid chamber(s) 140, 150 is/are advantageously formed such that, upon rotation of the rotor 120, fluid will flow though the fluid passages 125 and is transferred between the fluid chambers 140, 150. Responsive to fluid flowing through the fluid passages 125, a pumping action will be obtained, causing a braking action to the electrical machine 100.

In the example of FIG. 2A, the electrical machine 100 is provided with fluid return passages 101 radially between the rotor 120 and the stator 110. The fluid return passages 101 may, as shown in FIG. 2A be, arranged axially around the rotor 120. However, this is but one example and electrical machines 100 with one or more fluid return passages 101 each extending only partially around a circumference of the rotor 120 are well within the scope of the present disclosure. The one or fluid return passages 101 are, as the name suggest, provided to allow fluid to flow between the fluid chambers 140, 150 regardless of rotation of the rotor 120.

In FIG. 2B, the corresponding electrical machine 100 as in FIG. 2A is shown, but with fluid 102 inside the housing 130. In the first fluid chamber 140, the fluid 102 is at a first fluid level L1. In the second fluid chamber 150, the fluid 102 is a second fluid level L2 being different from the first fluid level L1. If the rotor 120 would be stationary, the fluid 102 would, due to the fluid passages 125 and the fluid return passage 101 level such that the first fluid level L1 is substantially equal to the second fluid level (assuming the electrical machine 100 is arranged with the rotational axis A horizontal). Due to the rotation of the rotor 102, fluid 102 will flow through the fluid passages 125 of the rotor 120 from the second fluid chamber 150 (right side in FIG. 2B) to the first fluid chamber 140 (left side in FIG. 2A). The pumping action provided by the rotor 120 will cause a pressure of the fluid 102 in the first fluid chamber 140 to increase. As the pressure increases, it will require more power to continue the pumping action of the rotor 120, and eventually a hydraulically locking effect will be provided by the difference in pressure between the fluid chambers 140, 150.

If a rotational direction of the rotor 120 was opposite to the one shown in FIG. 2B, the fluid levels would be reversed and the second fluid chamber 150 would be a high pressure side.

The electrical machine 100 in FIGS. 2A and 2B forms a closed fluid system in that fluid 102 never leaves the housing of the electrical machine 100. This exemplary embodiment will provide a braking effect as soon as a rotational speed of the rotor 120 causes a flow of fluid 102 through the fluid passages 125 that exceeds a flow permitted by the fluid return passages 101. By dimensioning e.g. the fluid return passages 101, the fluid passages 125 the electrical machine 100 may be configured to brake at a predetermined rotational speed of the rotor 120. This may be usable as e.g., an emergency brake in elevators or as a general over-speed governor of electrical machines 100. It should be noted that the electrical machine 100 is self-resettable as at standstill, the pressure of the fluid 102 in the fluid chambers will normalize and further operation of the machine is permitted.

In FIG. 3, a further exemplary electrical machine 100 is shown. In this example, the first fluid chamber 140 is provided with a first chamber fluid port 145 and the second fluid chamber 150 is provided with a second chamber fluid port 155. The fluid ports 145, 155 are provided to fluidly fill and/or drain the respective fluid chambers 140, 150. In FIG. 3, the electrical machine is formed without the fluid return passage 101 and a fluid return path will be provided by fluidly connecting the first chamber fluid port 145 to the second chamber fluid port 155 by a fluid port return passage 103, fluid return passage 103 for short. It should be noted that the fluid ports 145, 155 may very well be combined with the fluid return passage between the rotor 120 and the stator 110.

In the example of FIG. 3, the fluid return passage 103 is provided with a controllable valve device 104. In some examples, more than one controllable valve devices 104 may be provided along the fluid return passage 103. The controllable valve device 104 is configurable to control a flow of fluid 102 in the fluid port return passage 103. In some examples, the controllable valve device 104 is controller between an open state and a closed state. When at the open state, fluid 102 may flow between the fluid chambers 140, 150 by the fluid passages 125 of the rotor 120 and by the fluid return passage 103. Assuming that the fluid return passage 103 is dimensioned to permit a flow of fluid 102 equal to, or exceeding a flow of fluid 102 permitted by the fluid passages 125 of the rotor 120, the pressure in the respective fluid chambers 140, 150 will be substantially the same. However, if the controllable valve device 104 is at its closed state, fluid 102 will not be permitted to flow between the fluid chamber by the fluid return passage 103 and a difference in pressure between the fluid chambers 140, 150 will provided. This difference in pressure will, as explained above, provide a braking torque on the rotor 120. The controllable valve device 104 enables control of braking of the electrical machine 100.

It should be mentioned that the controllable valve device 104 may be linearly, or proportionally controlled such that it may controlled to partly open or close depending on e.g. control signals provided to the proportional valve device 104.

The fluid port return passage 103 is in FIG. 3 shown as external to the housing 130. This is one example, and the fluid port return passage 103 may very well be arranged inside the housing 130, forming part of the housing 130 or a combination thereof. In some examples, the fluid return passage 103 is, at least partly, internal to the stator 110.

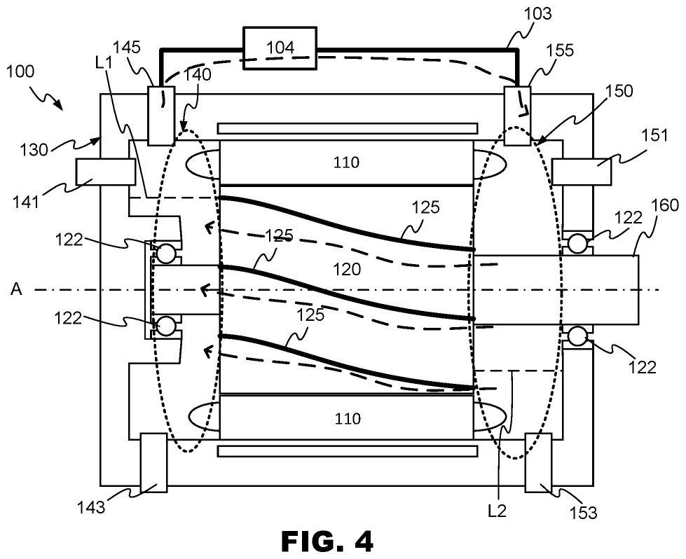

In FIG. 4, a further example of the electrical machine 100 is shown. In this example, the first fluid chamber 140 and the second fluid chamber 150 each comprises three fluid ports 141, 143, 145, 151, 153, 155. Each of the fluid ports 141, 143, 145, 151, 153, 155 may be bidirectional fluid ports, but in this example, the vertically lower ports 143, 153 may be outlets for draining fluid 102 from the chambers 140, 150 and the vertically higher ports 141, 151 may be inlets for receiving fluid 102. Providing fluid outlets 143, 145 vertically below fluid inlets 141, 151, will allow for drainage of the associated fluid chamber 140, 150 by means of gravity.

Although not shown in FIG. 4, the fluid outlet 143 of the first fluid chamber 140 is advantageously connected to the fluid inlet 151 of the second fluid chamber 150. Correspondingly, the fluid outlet 153 of the second fluid chamber 150 is advantageously connected to the fluid inlet 141 of the first fluid chamber 140.

The example in FIG. 4 is shown comprising both the fluid return passage 103 and associated ports 145, 155 introduced in FIG. 3 and the fluid inlets 141, 151 and outlets 143, 153. This is to show that these features may be combined, but it should be mentioned that they may very well be separated and implemented individually. Further, in some examples, wherein e.g. the electrical machine 100 only rotates in one direction, only one fluid chamber 140, 150 may be provided with a fluid inlet 141, 151 and the other fluid chamber may be provided with a fluid outlet 143, 153.

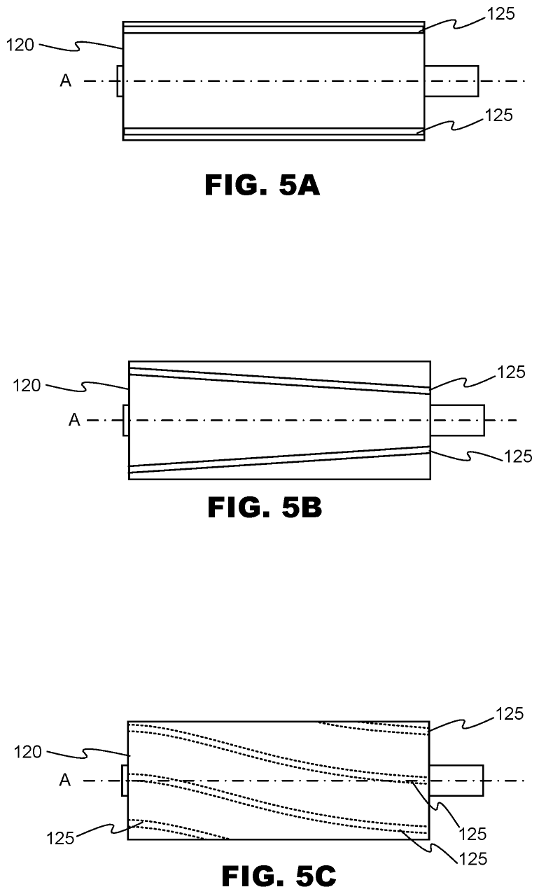

The fluid passages 125 may be configured according to various principles, as exemplified in FIGS. 5A-C. Starting in FIG. 5A, the rotor 120 is shown in cross-section. The rotor 120 is provided with a plurality of fluid passages 125, or oil channels, arranged at an outer radius (i.e. close to the outer circumference of the rotor 120). The fluid passages 125 as shown in FIG. 5A extend straight through the rotor 120, at a constant radius.

In FIG. 5B another example is shown also in cross-section. Here, the fluid passages 125 extend straight through the rotor 120 but at a varying, in particular an increasing, radius. At a first axial side (i.e. the low pressure side) the fluid passages 125 are arranged at an inner radius, while their radial position increase along the rotor 120. At an opposite axial side, the fluid passages 125 are arranged at an outer radius.

In FIG. 5C a further example is shown. Here, the fluid passages 125 are no longer straight, but the circumferential position is varying along the length of the rotor 120. In particular, each fluid passages 125 is twisted whereby the length of each fluid passages 125 is increased in comparison to straight fluid passages 125. The twist angle may be small (as shown in FIG. 5C) or significantly larger, resulting in a helical distribution of a fluid passages 125.

It should be mentioned that the different examples of the fluid passages 125 shown in FIGS. 5A-C are non-limiting examples and many different arrangements and formations of the fluid passages 125 are possible. Further, the different examples of FIGS. 5A-C may very well be combined with each other in any suitable way.

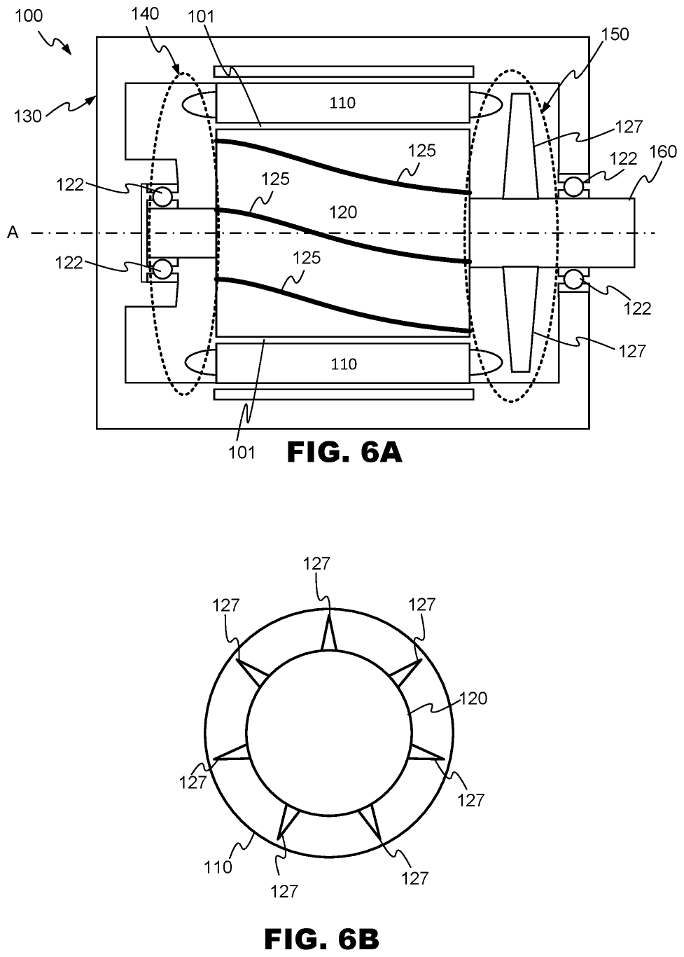

In FIG. 6A, the corresponding electrical machine 100 of FIG. 2A is shown but with an optional axial flow pump 127 is provided in order to enhance the pumping effect provided by the fluid passages 125. The axial flow pump 127 is in this example shown as an impeller 127, arranged on the rotor 120 at the second fluid chamber 150. When the rotor 120 is spinning, the impeller 127 will throw oil from the first axial side S1 towards the opposite axial side, i.e. the first fluid chamber 140, thereby causing a forced fluid flow through the fluid passages 125. Preferably, the axial flow pump 127 is designed to direct the flow of fluid 102 towards a center of the rotor 120 rather than spraying the fluid radially outwards.

In FIG. 6B, a partial cross sectional view of the electrical machine 100 is shown looking along the a rotational axis A. In this example, the axial flow pump 127 is an impeller with a plurality of impeller elements 127 distributer around the rotor 120 and extending radially from the rotor 120.

It should however be appreciated that the pumping effect may be achieved also without the provision of an axial flow pump 127, as the increase of oil at one axial side will cause the oil to flow through the fluid passage(s) 125 to the opposite axial side of the rotor 120. Further to this, there may be an axial flow pump 127 provided at each axial side of the rotor 120, i.e. at each fluid chamber 140, 150. In such examples, each axial fluid pump 127 is advantageously formed such that it a direction of the fluid 102 flowed by the axial pump may be reversed by reversing a rotational direction of the rotor 120. This further implies that an axial fluid pump 127 provided at a high pressure side of the rotor will provide an axial sucking action on the fluid passages 125 and an axially opposite fluid pump will provide an axial blowing action on the fluid passages 125.

Returning to FIG. 1, wherein a vehicle 10 comprising the electrical machine 100 was shown. The electrical machine 100 is advantageously a propulsion motor 100 of the vehicle 10, but may in some examples be an alternator of the vehicle 10. Regardless, the electrical machine 100 may be the electrical machine 100 according to any suitable example presented herein.

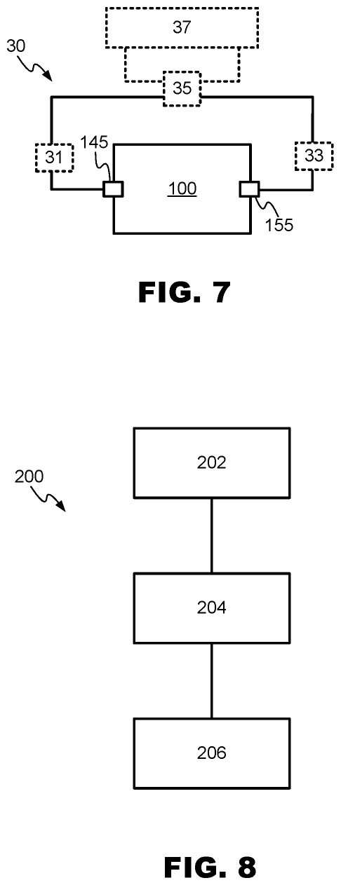

In FIG. 7, the electrical machine 100 is shown when forming part of the vehicle 10. In this example, the electrical machine 100 comprises the first chamber fluid port 145 and the second chamber fluid port 155. The first chamber fluid port 145 and the second chamber fluid port 155 are connected by a fluid circuit 30. The fluid circuit 30 may form a return passage for the fluid 102 in addition to, or in place of, the fluid return passage 101 and/or the fluid port return passage 103.

The fluid circuit 30 may comprise one or more pump devices 35. The pump device 35 may be configurable to pump fluid into/out from the first fluid chamber 140 or the second fluid chamber 150 of the electrical machine 100. The pump device 35 will increase the pumping and/or draining effect of the fluid passages 125 depending on arrangement and rotation of the rotor 120. If the pump device 35 is configured to pump fluid 102 into the first fluid chamber 140, and the rotation of the rotor 120 is such that fluid is moved from the first fluid chamber 140 to the second fluid chamber 150, the fluid pumped into the first fluid chamber will flow to the second fluid chamber 150 and exert a braking torque on the rotor 120. This will increase the flow of oil into the first fluid chamber and decrease a time it takes before the electrical machine 100 is braked. If the pump device 35, e.g. at a later stage of operation, is configured to drain fluid 102 from the second fluid chamber 150, a time it takes to decrease and remove a braking force exerted by the fluid 102 on the rotor 120 will decrease and the electrical machine 100 may operate without any braking torque applied via the fluid 102.

Advantageously, each side of the fluid circuit 30, i.e. at both sides of the pump device 35, valve devices 31, 33 are provided. If the electrical machine 100 is configured to operate in only one direction, one valve device 31, 33 may suffice, advantageously a drain valve device 31, 33 at the fluid port 145, 155 at the high pressure fluid chamber 140, 150. Such a drain valve device 31, 33 is provided to prevent fluid 102 from draining the high pressure fluid chamber 140, 150. Optionally, an inlet valve device 31, 33 may be provided between the pump device 35 and the other of the fluid ports 145, 155.

The fluid circuit 30 may further comprise a fluid reservoir 37. The fluid reservoir 37 may be a sump or any other suitable reservoir 37. The pump device 35 may be configured to pump fluid 102 between the reservoir 37 and the fluid circuit 30.

As the fluid 102 brakes the rotor 120 of the electrical machine 100. The friction caused between the fluid and the rotor 120 may cause the fluid 102 to heat. In order to dissipate this heat, the fluid circuit may be operatively connected to, or form part of a temperature system of the vehicle 10. The temperature system may be configured to transfer heat to e.g. an interior of the vehicle 10 and/or to the energy system 20 of the vehicle 10.

As previously indicated, the fluid 102 is advantageously an oil.

With reference to FIG. 8, a method 200 for braking an electrical machine 100 is schematically shown. The method 200 may be performed e.g. by the electrical machine 100 according to any suitable example of the present disclosure.

The method 200 comprises providing 202 fluid 102 to a first axial side of the electrical machine 100, i.e. to a first fluid chamber 140, 150 of the electrical machine 100.

The method 200 further comprises pumping 204, responsive to rotation of a rotor 120 of the electrical machine 100, the fluid 102 from the first axial side, i.e. from the first fluid chamber 140, of the electrical machine 100 to a second, opposite axial side, i.e. the second fluid chamber 150, of the electrical machine 100 through at least one fluid passage 125 extending along the rotor 120 of the electrical machine 100.

The method 200 further comprises controlling 206 a reverse flow of fluid 102 from the second fluid chamber 150 to the first fluid chamber 140 such that the flow through the at least one fluid passage 125 exceeds the reverse flow, whereby a braking torque is exerted on the rotor 120 by the fluid 102 of the second fluid chamber. The reverse flow may be controlled by dimensioning the fluid return passages 101, 103 and/or the fluid circuit 30 in relation to the fluid passages 125 such that the braking effect is provided at a specific speed. Alternatively, or additionally, the reverse flow may be controlled by controlling valves 31, 33, 104 in a flow of the reverse flow.

Example 1. An electrical machine 100 comprising a rotor 120, a stator 110, a housing 130 and a first and a second fluid chamber 140, 150 in fluid communication via at least one fluid passage 125 of the rotor 120, wherein the rotor 120 upon rotation is adapted to provide a difference in pressure between the first fluid chamber 140 and the second fluid chamber 150 by transfer of fluid 102 there between, whereby a braking torque is exerted on the rotor 120.

Example 2. The electrical machine 100 of Example 1, wherein the first and second fluid chambers 140, 150 are provided at, along a rotational axis A of the electrical machine 100, respective opposite sides of the rotor 120.

Example 3. The electrical machine 100 of Example 2, wherein the first and second fluid chambers 140, 150 are provided between an interior of the housing 130 and the rotor 120.

Example 4. The electrical machine 100 of any one of the preceding Examples, further comprising at least one fluid return passage 101, 103 provided between the first fluid chamber 140 and the second fluid chamber 150.

Example 5. The electrical machine 100 of Example 4, wherein at least one internal fluid return passage 101 is provided between the stator 110 and the rotor 120.

Example 6. The electrical machine 100 of any one of the preceding Examples, wherein the first fluid chamber 140 is provided with a first chamber fluid port 145 for fluidly filling and/or draining the first fluid chamber 140 and the second fluid chamber 150 is provided with a second chamber fluid port 155 for fluidly filling and/or draining the second fluid chamber 150.

Example 7. The electrical machine 100 of Example 6, wherein the first chamber fluid port 145 is in fluid communication with the second chamber fluid port 155 by a fluid port return passage 103.

Example 8. The electrical machine 100 of Example 7, wherein the fluid port return passage 103 between the first and second chamber fluid ports 145, 155 is provided with at least one controllable valve device 104 configurable to control a flow of fluid 102 in the fluid port return passage 103.

Example 9. The electrical machine 100 of any one of the preceding, wherein the first fluid chamber 140 comprises a first chamber fluid inlet 141, 145 for receiving fluid 102 and a first chamber fluid outlet 143, 145 for draining fluid 102, and the second fluid chamber 150 comprises a second chamber fluid inlet 151, 155 for receiving fluid 102 and a second chamber fluid outlet 153, 155 for draining fluid 102.

Example 10. The electrical machine 100 of any one of the preceding Examples, wherein the rotor 120 is provided with at least one impeller 127 arranged at the first or the second fluid chamber 140, 150 of the electrical machine 100.

Example 11. The electrical machine 100 of any one of the preceding Examples, wherein the electrical machine 100 is a propulsion motor for a vehicle 10.

Example 12. A vehicle 10 comprising the electrical machine 100 according to any of the preceding Examples.

Example 13. The vehicle 10 of Example 12, wherein the electrical machine 100 is a propulsion motor of the vehicle 10.

Example 14. The vehicle 10 of Example 12 or 13, wherein the electrical machine 100 is the electrical machine 100 of any one of Examples 6 to 11, and the vehicle 10 further comprises a fluid circuit 30 connected between the first chamber fluid port 145 and the second chamber fluid port 155.

Example 15. The vehicle 10 of Example 14, wherein the fluid circuit 30 comprises at least one pump device 35 configurable to pump fluid 102 into the first fluid chamber 140 or the second fluid chamber 150 and at least one drain valve device 31, 33 configurable to prevent fluid 102 from draining from the other of the first fluid chamber 140 or the second fluid chamber 150.

Example 16. The vehicle 10 of Example 15, wherein an inlet valve device 31, 33 is provided between the pump device 35 and the fluid receiving one of the first chamber fluid port 145 and the second chamber fluid port 155.

Example 17. The vehicle 10 of any one of Examples 14 to 16, wherein the fluid circuit 30 further comprises a fluid reservoir 37.

Example 18. The vehicle 10 of any one of Examples 14 to 17, wherein the fluid circuit is operatively connected to a temperature system of the vehicle.

Example 19. The vehicle 10 of any one of Examples 12 to 18, wherein the fluid 102 transferred between the first and a second fluid chambers 140, 150 is an oil based fluid.

Example 20. The vehicle 10 of any one of Examples 12 to 19, wherein the vehicle is a heavy-duty vehicles, such as a truck, a bus, or a construction equipment.

Example 21. A method 200 for braking an electrical machine 100 of any one of Examples 1 to 11, the method 200 comprises: providing 202 fluid 102 to a fluid chamber 140, 150 at a first axial side of the electrical machine 100; pumping 204, responsive to rotation of a rotor 120 of the electrical machine 100, the fluid 102 from the fluid chamber 140, 150 at the first axial side of the electrical machine 100 to a fluid chamber 140, 150 at a second opposite axial side of the electrical machine 100 through at least one fluid passage 125 extending along the rotor 120 of the electrical machine 100; and controlling 206 a reverse flow of fluid 102 from the second axial side to the first axial side such that the flow through the at least one fluid passage 125 exceeds the reverse flow, whereby a braking torque is exerted on the rotor 120 by the fluid 102 at the second axial side of the electrical machine 100.

Example 22. The electrical machine 100 of Example 1, wherein the first and second fluid chambers 140, 150 are provided at, along a rotational axis A of the electrical machine 100, respective opposite sides of the rotor 120; the first and second fluid chambers 140, 150 are provided between an interior of the housing 130 and the rotor 120; the electrical machine 100 further comprising at least one fluid return passage 101, 103 provided between the first fluid chamber 140 and the second fluid chamber 150, at least one internal fluid return passage 101 is provided between the stator 110 and the rotor 120; the first fluid chamber 140 is provided with a first chamber fluid port 145 for fluidly filling and/or draining the first fluid chamber 140 and the second fluid chamber 150 is provide with a second chamber fluid port 155 for fluidly filling and/or draining the second fluid chamber 150, the first chamber fluid port 145 is in fluid communication with the second chamber fluid port 155 by a fluid port return passage 103, wherein the fluid port return passage 103 between the first and second chamber fluid ports 145, 155 is provided with at least one controllable valve device 104 configurable to control a flow of fluid 102 in the fluid port return passage 103; the first fluid chamber 140 comprises a first chamber fluid inlet 141, 145 for receiving fluid 102 and a first chamber fluid outlet 143, 145 for draining fluid 102, and the second fluid chamber 150 comprises a second chamber fluid inlet 151, 155 for receiving fluid 102 and a second chamber fluid outlet 153, 155 for draining fluid 102; the at least one fluid passage 125 of the rotor 120 is provided by an impeller 127 of the rotor 120, wherein the electrical machine 100 is a propulsion motor for a vehicle 10.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

1. An electrical machine comprising a rotor, a stator, a housing and a first and a second fluid chamber in fluid communication via at least one fluid passage of the rotor and at least one fluid return passage provided between the first fluid chamber and the second fluid chamber, wherein the rotor upon rotation is adapted to provide a difference in pressure between the first fluid chamber and the second fluid chamber by transfer of fluid there between, whereby a braking torque is exerted on the rotor, wherein the first and second fluid chambers are provided at, along a rotational axis of the electrical machine, respective opposite sides of the rotor.

2. The electrical machine of claim 1, wherein the first and second fluid chambers are provided between an interior of the housing and the rotor.

3. The electrical machine of claim 1, wherein at least one internal fluid return passage is provided between the stator and the rotor.

4. The electrical machine of claim 1, wherein the first fluid chamber is provided with a first chamber fluid port for fluidly filling and/or draining the first fluid chamber and the second fluid chamber is provided with a second chamber fluid port for fluidly filling and/or draining the second fluid chamber.

5. The electrical machine of claim 4, wherein the first chamber fluid port is in fluid communication with the second chamber fluid port by a fluid port return passage.

6. The electrical machine of claim 5, wherein the fluid port return passage between the first and second chamber fluid ports is provided with at least one controllable valve device configurable to control a flow of fluid in the fluid port return passage.

7. The electrical machine of claim 1, wherein the first fluid chamber comprises a first chamber fluid inlet for receiving fluid and a first chamber fluid outlet for draining fluid, and the second fluid chamber comprises a second chamber fluid inlet for receiving fluid and a second chamber fluid outlet for draining fluid.

8. The electrical machine of claim 1, wherein the rotor is provided with at least one impeller arranged at the first or the second fluid chamber of the electrical machine.

9. The electrical machine of claim 1, wherein the electrical machine is a propulsion motor for a vehicle.

10. The electrical machine of claim 1, wherein the first and second fluid chambers are provided at, along a rotational axis of the electrical machine, respective opposite sides of the rotor; the first and second fluid chambers are provided between an interior of the housing and the rotor; the electrical machine further comprising at least one fluid return passage provided between the first fluid chamber and the second fluid chamber, at least one internal fluid return passage is provided between the stator and the rotor; the first fluid chamber is provided with a first chamber fluid port for fluidly filling and/or draining the first fluid chamber and the second fluid chamber is provide with a second chamber fluid port for fluidly filling and/or draining the second fluid chamber, the first chamber fluid port is in fluid communication with the second chamber fluid port by a fluid port return passage, wherein the fluid port return passage between the first and second chamber fluid ports is provided with at least one controllable valve device configurable to control a flow of fluid in the fluid port return passage; the first fluid chamber comprises a first chamber fluid inlet for receiving fluid and a first chamber fluid outlet for draining fluid, and the second fluid chamber comprises a second chamber fluid inlet for receiving fluid and a second chamber fluid outlet for draining fluid; the at least one fluid passage of the rotor is provided by an impeller of the rotor, wherein the electrical machine is a propulsion motor for a vehicle.

11. A vehicle comprising the electrical machine according to claim 1.

12. The vehicle of claim 11, wherein the electrical machine is a propulsion motor of the vehicle.

13. A vehicle comprising the electrical machine of claim 4, and the vehicle further comprises a fluid circuit connected between the first chamber fluid port and the second chamber fluid port.

14. The vehicle of claim 13, wherein the fluid circuit comprises at least one pump device configurable to pump fluid into a first fluid chamber or the second fluid chamber and at least one drain valve device configurable to prevent fluid from draining from the other of the first fluid chamber or the second fluid chamber.

15. The vehicle of claim 14, wherein an inlet valve device is provided between the pump device and the fluid receiving one of the first chamber fluid port and the second chamber fluid port.

16. The vehicle of claim 15, wherein the fluid circuit further comprises a fluid reservoir.

17. The vehicle of claim 13, wherein the fluid circuit is operatively connected to a temperature system of the vehicle.

18. The vehicle of claim 11, wherein the vehicle is a heavy-duty vehicle, such as a truck, a bus, or a construction equipment.

19. A method for braking an electrical machine of claim 1, the method comprises:
providing fluid to a fluid chamber at a first axial side of the electrical machine,
pumping, responsive to rotation of a rotor of the electrical machine, the fluid from the fluid chamber at the first axial side of the electrical machine to a fluid chamber at a second opposite axial side of the electrical machine through at least one fluid passage extending along the rotor of the electrical machine, and
controlling a reverse flow of fluid from the second axial side to the first axial side such that the flow through the at least one fluid passage exceeds the reverse flow, whereby a braking torque is exerted on the rotor by the fluid at the second axial side of the electrical machine.
